(19) United States
(12) Patent Application Publication
(10) Pub. No.: US 2008/0044788 A1
(43) Pub. Date: Feb. 21, 2008

(54) DOUBLE ENDED LIGHTED DENTAL CLEANER

(76) Inventors: John M. Jansheski, Maryville, TN (US); Lex Shankle, Maryville, TN (US)

Correspondence Address: LUEDEKA, NEELY & GRAHAM, P.C., P O BOX 1871, KNOXVILLE, TN, 37901, US

(21) Appl. No.: 11/465,593

(22) Filed: Aug. 18, 2006

(51) Int. Cl. A61C 1/00

(52) U.S. Cl. 433/29

(57) ABSTRACT

A lighted dental cleaning and inspection device. The device includes a handle having an end including a dental tool and an illumination source positioned and operable to direct light toward a tip portion of the dental tool; and an electrical circuit located substantially within the handle and being operable to selectively enable illumination of the illumination source to illuminate the tip portion of the dental tool and an area of interest during use of the dental tool at the site of interest.

### FIELD

This invention relates to the field of dental cleaning devices. More particularly, this invention relates to a dental cleaning device which in one embodiment includes a dental cleaning device and an illumination source configured to illuminate a portion of the cleaning device during use at a site of interest.

### BACKGROUND

Improvement is desired in the construction of dental cleaning devices of the type used by individuals for self oral care, as contrasted to devices of the type used by dental professionals. The former type need to be small, lightweight, portable, and inexpensive. What is desired is a device for use by individuals that facilitates inspection of the mouth and which can be used to remove of food particles, tarter, plaque, and general debris from the teeth and to clean the teeth.

What is needed, therefore, is a device which facilitates inspection of the mouth by providing illumination and which can be used to remove food particles, tarter, plaque, and general debris and to clean the teeth. Such a device having a plurality of dental workpieces is also needed.

### SUMMARY

The above and other needs are met by lighted dental cleaning and inspection device. In one preferred embodiment, the device includes a handle having an end including a dental tool and an illumination source positioned and operable to direct light toward a tip portion of the dental tool. An electrical circuit located substantially within the handle and being operable to selectively enable illumination of the illumination source to illuminate the tip portion of the dental tool and an area of interest during use of the dental tool at the site of interest.

In another preferred embodiment, the device is double-ended and includes a handle having first and second ends. The first end includes a first dental tool and a first illumination source. The second end includes a second dental tool and a second illumination source.

In preferred embodiments, an electrical circuit may be located substantially within the handle and is operable to selectively enable illumination of the first and second illumination sources to selectively illuminate tip portions of the first and second dental tools and respective areas of interest during respective use of the dental tools at the sites of interest.

In other preferred embodiments, an electrical switch is provided in the handle portion which is operable by a user to selectively activate and deactivate the illumination source. The handle portion houses a controller that is electrically coupled to the illumination source. In a preferred embodiment, the controller automatically deactivates the illumination source after a predetermined period of time to conserve battery power.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a perspective view of a dental cleaning device according to a preferred embodiment of the disclosure.

FIG. 2 is a close-up view of an end of the device of FIG. 1.

FIG. 3 is an exploded view of the device of FIG. 1.

FIG. 4 is a schematic of an electrical circuit used in the device of FIG. 1.

### DETAILED DESCRIPTION

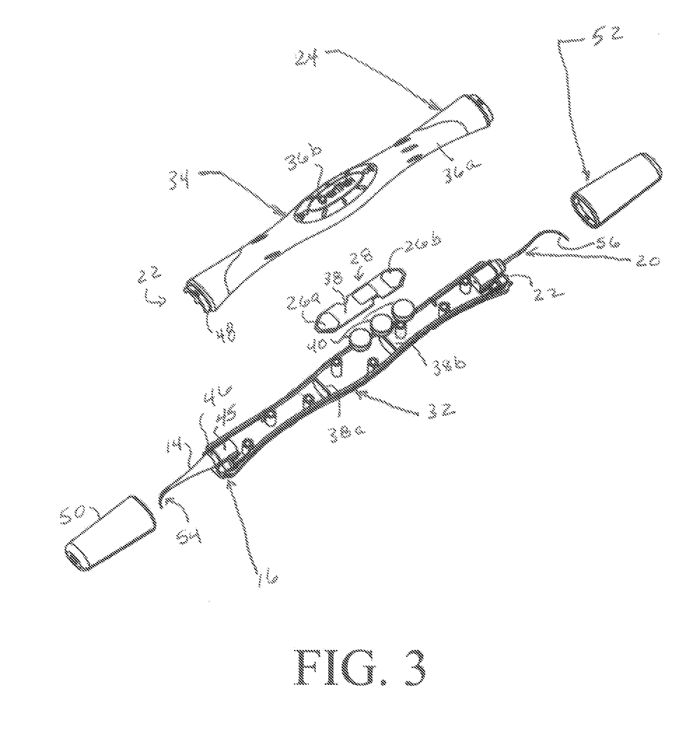

With reference to the drawings, the disclosure relates to a lightweight and portable dental inspection and cleaning device 10 for use by individuals for self oral care. The device 10 includes a handle 12 having a first dental tool 14 and a first illumination source 16 at a first end 18 thereof, and a second dental tool 20 and a second illumination source 22 at a second end 24 thereof. Switches 26a and 26b and an associated electrical circuit 28 (FIG. 3) enable a user to selectively illuminate the first and second illumination sources 16 and 22. The dental tools may encompass a variety of dental tools for precise interaction with the teeth of a user.

In this regard, it is noted that the illumination devices are advantageously configured to direct light to the point of interaction of the dental tool with the teeth or tooth of a user to enhance visibility of the working portion of the dental tool at the site of interest. Thus, a third party user or a user with the aid of a mirror may achieve improved visibility of the locations to be cleaned or otherwise interacted with by the dental tool. For example, when attempting to dislodge a popcorn kernel, a user may have difficulty locating the edge of the kernel with a pick by feel alone or without illumination. Thus, by utilizing the device of the disclosure, a user may, with the aid of a mirror, either handheld or mounted, more easily light and view the point of the dental pick and the site of interest and more easily determine when the pick is adjacent the edge of the kernel. Then, once the kernel is removed, the user may perform additional cleaning by use of the second dental device and associated illumination source.

With reference to FIG. 3, the handle 12 includes a lower housing 32 and an upper housing 34, each of molded plastic construction and configured to have corresponding crush pins and cylinders for snap-fit construction. The exterior surfaces of the housings 32 and 34 preferably include overmolded portions 36a-36b made of an elastomeric material, such as thermoplastic elastomeric (TPE) resins, for aesthetics and to enhance gripping by a user. A variety of plastics of the type used to make thin-wall handles may be used to make the housings 32 and 34, including flexible polyolefin plastics and the like.

The housings 32 and 34 are each semi-cylindrical and support, preferably at a central location, the electrical circuit 28, which is preferably provided as by a printed circuit board 38, batteries 40 and associated wiring leading from the board 38 internally within the handle 12 to each of the illumination sources 16 and 22. Supports 38a and 38b are preferably provided on the housings 32 and 34 to support the printed circuit board 38.

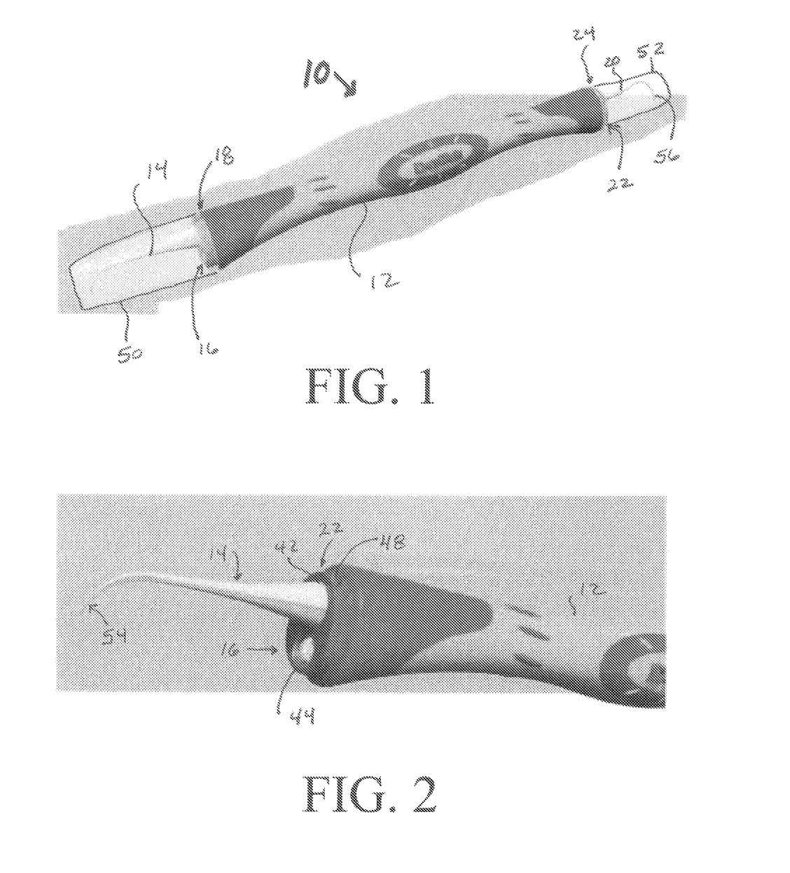

Each of the ends 22 and 24 of the assembled handle 12 preferably defines a pair of apertures, such as apertures 42 and 44 defined on the end 22 (FIG. 2), to locate the dental devices 14 and 20, and the illumination sources 16 and 22, respectively.

The first dental tool 14 is configured as a scaler to remove tartar and plaque. The tool 14 preferably includes a base 45 having a circumferential groove 46 adjacent its proximal end which is configured mate with the aperture 42 to frictionally retain the tool 14 in position at the end 22. In this regard, the groove 46 and/or the adjacent edges of the tool 14 and the aperture 42 may have cooperating topographies to substantially lock the tool 14 in position and resist rotation during use. An adhesive or the like may also be used to retain the first dental tool 14. The dental tool 14 is preferably made of stainless steel and the base 45 made of molded plastic or stainless steel. The tool 14 may be inserted into an aperture of the base 45 or the base 45 molded about the proximal end of the dental tool. Alternatively, the tool 14 and base structure may be entirely of one-piece molded plastic or stainless steel construction.

The end 22 is preferably configured to provide a shoulder 48 to fittingly receive a cap 50 configured to fit over the tool 14 and protect it and keep it clean when not in use. However, it will be understood that the cap 50 is optional and may or may not be included.

The second dental tool 20 is configured as a so-called explorer pick for dislodging food and other debris from between teeth and around the gums. The tool 20 is constructed in a manner similar to that of the tool 14 and configured to have a proximal end similar to that of the tool 14 and preferably includes a circumferential groove configured to mate with an aperture defined on the end 24 to retain the tool 20 in position at the end 24. The end 24 is also preferably configured to provide a shoulder to fittingly receive a cap 52 configured to fit over the tool 20 and protect it and keep it clean when not in use. However, it will be understood that the cap 52 is optional and may or may not be included.

The device 10 may also be made to have replaceable dental tools that can be interchanged as by use of a quick-release receiver located in the ends of the device configured to releasably receive the dental tools 14 and 20 (and other configured dental tools).

The first illumination source 16 is preferably a light emitting diode configured and fixedly positioned, as by use of adhesive or a friction fit, adjacent the aperture 44 to selectively provide, by operation of the switch 26a, illuminating light directed to a tip portion 54 of the first dental tool 14. A preferred light emitting diode has a luminous intensity of about 1 candela. As explained in more detail below, a user may operate the switch 26a by pressing a predetermined location on the handle 12, it being understood that the plastic utilized to make the handle 12 has sufficient flex to permit the switch 26a to be operated by pressing on a portion of the handle 12 immediately adjacent the switch 26a. Alternatively, the switch may extend outside the surface of the handle, however, it is preferred that the handle represent a substantially sealed structure so as to be unaffected as by rinsing with water and the like.

The second illumination source 18 is preferably substantially identical to the first illumination source and is located adjacent a corresponding aperture in the end 24 to selectively provide, by operation of the switch 26b, illuminating light directed to a tip portion 56 of the second dental tool 20.

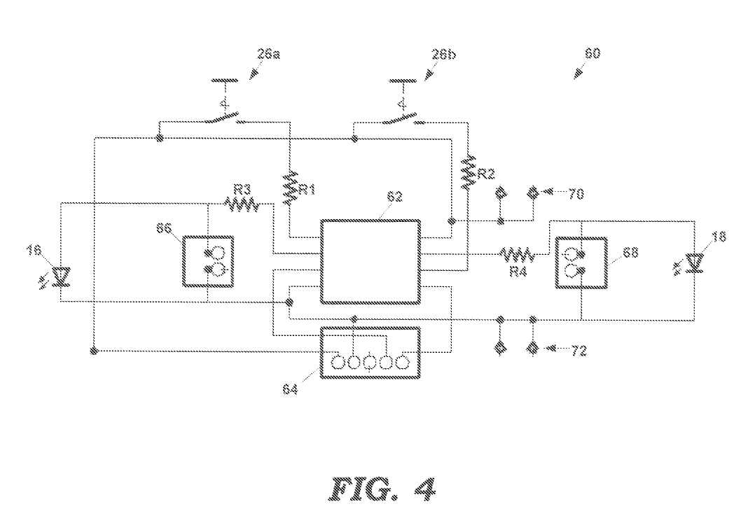

With reference to FIG. 4, there is shown a schematic of a preferred embodiment of an electrical circuit 60 for controlling activation of the first and second illumination sources 16 and 18. The circuit 60 includes a microprocessor controller 62, such as a “programmable system on a chip” (PSOC) having model number CY8C21123-24SXI manufactured by Cypress. The controller 62 enables the use of the momentary dome switches 26a and 26b, such as part number F12340 manufactured by Snaptron. Not only does the controller 62 selectively activate the illumination sources 16 and 18, but it also automatically shuts them off after a predetermined time to conserve battery power. In the preferred embodiment, the illumination sources 16 and 18 are configured for illumination purposes and are preferably white (or visible) light emitting diodes (LEDs), such as part number 67-1690-ND manufactured by Lumex, which are received in connection ports 66 and 68. The circuit 60 may include a programming port 64 for programming the controller 62. Positive and negative battery terminals 70 and 72 are provided for connection of the batteries 40 (FIG. 3). In a preferred embodiment of the circuit 60, the resistors R1 and R2 have values of 50 KΩ, and resistors R3 and R4 have values of 50 Ω.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A dental cleaning and inspection device, comprising:
a handle having first and second ends, the first end including a first dental tool and a first illumination source, the second end including a second dental tool and a second illumination source; and
an electrical circuit located substantially within the handle and being operable to selectively enable illumination of the first and second illumination sources to selectively illuminate tip portions of the first and second dental tools. and areas of interest during use of the dental tool at the sites of interest.

2. The dental device of claim 1, wherein the handle includes first and second housing members of molded plastic construction.

3. The dental device of claim 1, wherein the first and second ends of the handle each define a pair of apertures, one for locating the respective dental tool and the other for locating the respective illumination source in an orientation relative to one another such that light from the illumination source is substantially directed to the tip portion of the dental tool.

4. The dental device of claim 1, wherein the first and second dental tools are selected from the group consisting of dental scalers and dental picks.

5. The dental device of claim 1, wherein the first and second illumination sources comprise light emitting diodes.

6. A dental cleaning and inspection device, comprising:
a handle having an end including a dental tool and an illumination source positioned and operable to direct light toward a tip portion of the dental tool; and
an electrical circuit located substantially within the handle and being operable to selectively enable illumination of the illumination source to illuminate the tip portion of the dental tool and an area of interest during use of the dental tool at the site of interest.
